(19) United States
(12) Patent Application Publication
(10) Pub. No.: US 2001/0039914 A1
(43) Pub. Date: Nov. 15, 2001

(54) GAUGE DIAL ZONE INDICATOR

(76) Inventor: MICHAEL J. CHESTER, GLEN ELLYN, IL (US)

Correspondence Address: MIKE CHESTER, IN. 752 FOREST AVE., GLEN ELLYN, IL, 60137, US

(21) Appl. No.: 09/345,958

(22) Filed: Jul. 1, 1999

Related U.S. Application Data
(60) Provisional application No. 60/092,231, filed on Jul. 9, 1998.

(51) Int. Cl. G01D 13/22

(52) U.S. Cl. 116/328

(57) ABSTRACT

A gauge dial zone indicator comprising a colored planar form having adhesive backing removably covered by a release liner, for affixing to a gauge face cover. To install the gauge dial zone indicator, the release liner is removed to expose the adhesive backing, whereupon the gauge dial zone indicator is then pressed to the gauge face cover. Alternatively, the indicator may be made of static cling material and is mounted on a paper or paper composite backing; the static cling material indicator would simply be peeled from its backing and pressed to the gauge face cover. A method of installing the gauge dial zone indicator further includes the steps of measuring a distance the gauge face is to be covered, and trimming the indicator to match that distance.

### CROSS-REFERENCE TO RELATED APPLICATION

This application claims the benefit of U.S. Provisional Patent Application Ser. No. 60/092,231, filed Jul. 9, 1998.

### BACKGROUND OF THE INVENTION

1. Field of the Invention

The present invention relates gauge dial zone indicators and more particularly, to devices for indicating and calling attention to certain desired zones on analog gauge faces.

2. Description of Related Art

Analog gauges are integral to the functioning of machinery in a wide variety of applications such as industrial, marine, automotive, agricultural and aviation. In these environments, it is crucial for the user to get a quick and accurate gauge reading so that he or she may make decisions impacting expensive machinery, which when not functioning properly, may even endanger lives.

Many gauges have indicators which indicate, for example, danger zones or zones for acceptable operating conditions. However given the wide variety of machinery with which a single gauge may be used, it is nearly impossible for a gauge manufacturer to print gauge faces with indications applicable to all machinery. For example, 50 psi of oil pressure may be perfectly acceptable in an automotive application, but may be dangerously low in an aviation application. It is therefore desirable to have a zone indicator that may be custom fit to the face cover of a gauge.

Gauge zone indicators are well known in the related art. For example, U.S. Pat. No. 201,637 which issued to J. E. Treat on Aug. 28, 1877, discloses a pressure gauge indicator. This invention has a helix-shaped rotating disk having contrasting colors. Unfortunately, there is no way for the proportion of these colors to be adjusted depending on the application used in conjunction with the gauge.

U.S. Pat. No. 1,328,941 which issued to G. Brewer on Jan. 27, 1920, discloses an adjustable dial for dial gauges having a plate that adjustably rotates within the bezel, whereupon moving the plate enables adjustment of the dial. This adjustable plate is integral to the dial and cannot be retrofit to other dials.

U.S. Pat. No. 3,621,811 which issued to L. L. Hill, Jr. on Nov. 23, 1971, discloses an indicating condition controller having a white face plate a 250° arcuate portion of contrasting color to indicate possible movement of a needle. This arcuate portion is integral to the controller and cannot be retrofit to other applications.

U.S. Pat. No. 3,654,892 which issued to S. G. Johnson on Apr. 11, 1972, discloses a zonal device and combination thereof with a dimensional dial indicator. This device has a flange having zones showing the dimensions of the dial gradations. The flange and dial are integral and cannot be retrofit to other applications.

U.S. Pat. No. 4,020,787 which issued to Castro et al. on May 3, 1977, discloses a visual altitude alerting indicator consisting of a ring surrounding a gauge face that is movable about the bezel of the gauge, in order to alert a pilot to the altitude he or she must safely maintain. The Castro patent disclosure is remote from the instant invention because no gauge sticker is taught.

Swiss Patent No. 317,521 which issued to Pierre Roch S.a.r.l. on Nov. 30, 1956, discloses an indicator for use in conjunction with a dial gauge. The invention comprises a transparent colored window with a portion that mounts to the bezel or housing of a round dial gauge. The indicator may be positioned about the housing of the gauge to indicate certain warning zones. Again, the Swiss patent teachings fail to suggest any gauge sticker of the type herein disclosed and claimed.

None of the above inventions and patents, taken either singly or in combination, is seen to describe the instant invention as claimed.

### SUMMARY OF THE INVENTION

The present invention provides a gauge dial zone indicator for affixing to an analog gauge face cover. Given the wide variety of applications with which analog gauges are used, factory marking of gauge zones are nearly impossible, as zones vary with the machinery used. The present invention enables the user to affix the gauge dial zone indicator to any analog gauge, thereby tailoring the invention and the gauge to the user's specific needs.

The invention comprises a colored planar form having adhesive backing removably covered by a release liner. To install the gauge dial zone indicator, the release liner is removed to expose the adhesive backing, whereupon the gauge dial zone indicator is then pressed to the gauge face cover. Alternatively, a static cling sticker may be used.

Accordingly, it is a principal object of the invention to provide a gauge zone indicator that may be easily affixed to any analog gauge.

It is another object of the invention to enable a user to view gauge zones while still being able to view characters present on the face of the gauge.

It is a further object of the invention to provide a gauge dial zone indicator that may easily be manufactured and marketed.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a top plan view of a gauge dial zone indicator form according to a first preferred embodiment of the present invention.

FIG. 2 is a bottom plan view of the trimmed gauge dial zone indicator according to a preferred embodiment of the present invention, showing the release liner partially pulled away to expose adhesive backing.

FIG. 3 is an exploded view of a gauge and the first embodiment of the gauge dial zone indicator prior to installation over a gauge face cover.

FIG. 4 is an environmental, perspective view of the first embodiment of the gauge dial zone indicator shown installed over a gauge face cover.

FIG. 5 is a plan view of a gauge dial zone indicator form according to a second preferred embodiment of the present invention.

FIG. 6 is an environmental, perspective view of the second embodiment of the gauge dial zone indicator shown installed over a gauge face cover.

Similar reference characters denote corresponding features consistently throughout the attached drawings.

### DETAILED DESCRIPTION OF THE PREFERRED EMBODIMENTS

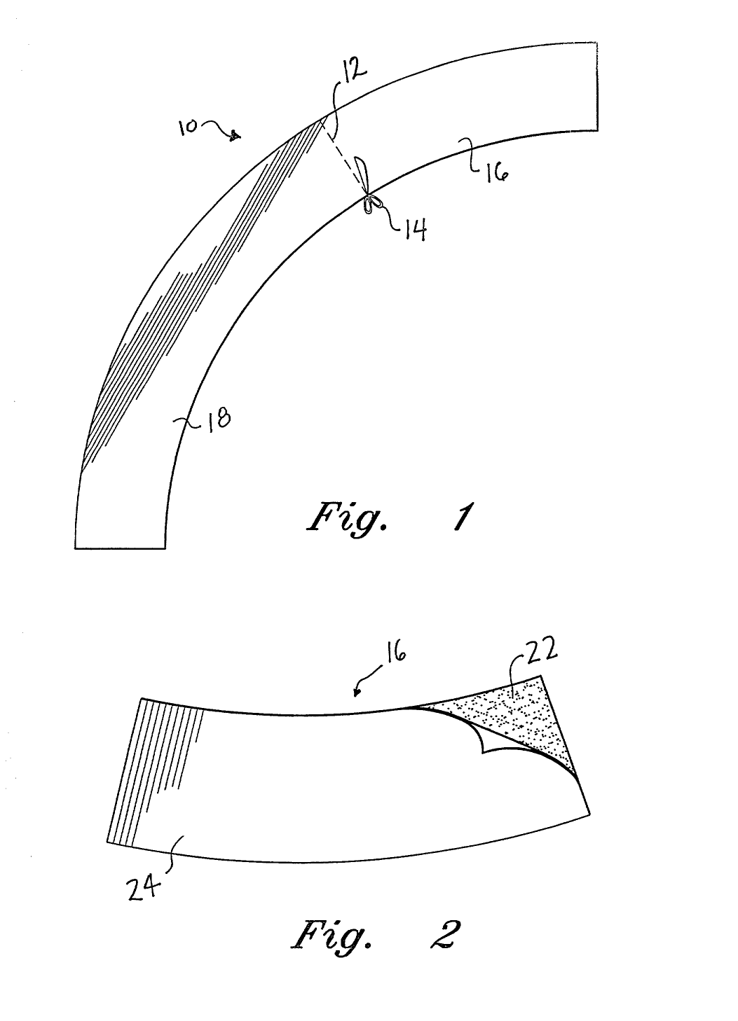

Referring now to the drawings wherein like numerals represent like elements, FIG. 1 shows a first preferred embodiment of a gauge dial zone indicator form 10. Given the wide variety of machinery with which a single gauge may be used, it is nearly impossible for a gauge manufacturer to print gauge faces with indications applicable to all machinery. There being no standardization of analog gauge dials, it is beneficial to provide the user with a form 10 large enough to cover zones of gauge dials of nearly any size, but which can be reduced to fit any desired gauge zone configuration. In the first preferred embodiment, the form 10 is a quarter quoit, but may take other shapes in alternative embodiments. In order to fit any desired gauge zone configuration, the form may be trimmed 12 by the user with a scissors 14 or any other cutting implement. Once trimmed to the appropriate configuration, a trimmed gauge dial zone indicator 16, shown in FIG. 2, may then be used in conjunction with any one of variously-sized gauges.

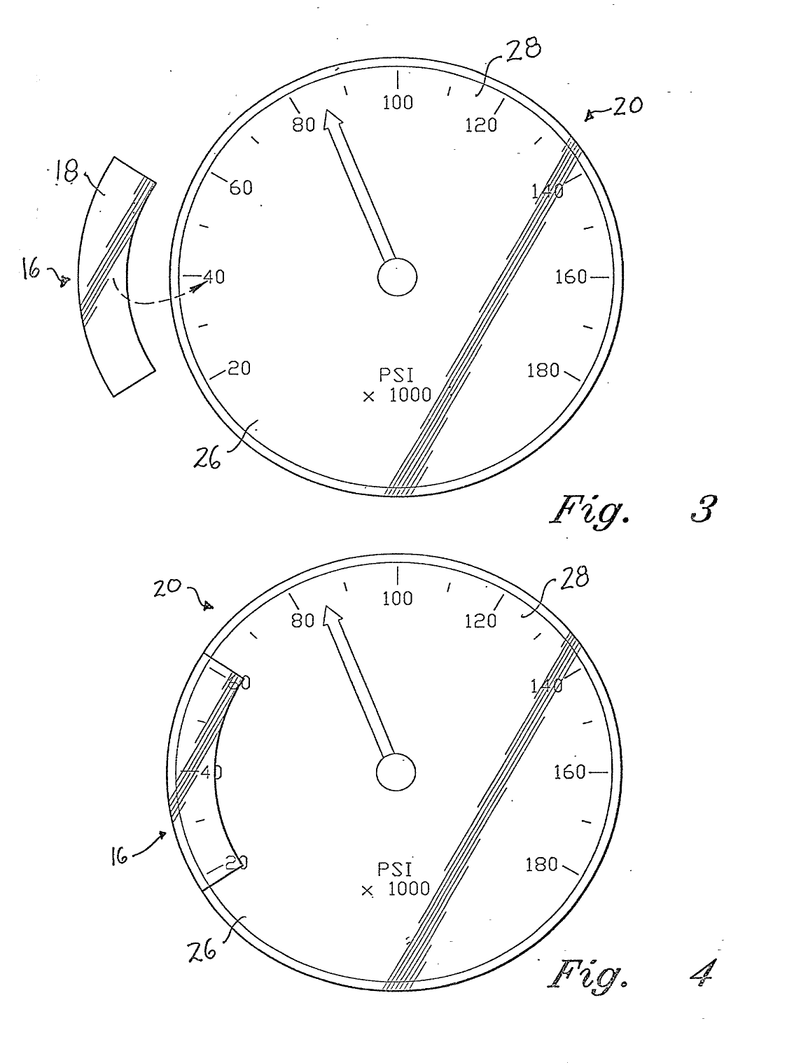

With reference to FIGS. 1 and 3, the gauge dial zone indicator 16 is comprised of colored vinyl 18, but may be comprised of other suitable materials in alternative embodiments. In the preferred embodiment, the gauge dial zone indicator 16 is transparent, thereby allowing the user to see characters printed on the gauge face, but may be opaque in alternative embodiments. The gauge dial zone indicator 16 also has a clear adhesive backing 22 that is covered by a release liner 24, as shown in FIG. 2. Alternatively, the gauge dial zone indicator may be fabricated from static cling material whereupon an adhesive backing would not be provided. Normally, such static cling sheets are mounted onto a paper or composite paper backing.

Referring now to FIG. 4, the gauge dial zone indicator 16 is shown affixed to a transparent gauge face cover 26 of an analog gauge 20. The advantage of a colored transparent indicator 16 is that the user may easily view the marked gauge zone area, while still being able to read the characters and needle on a gauge face 28.

The method of installing the gauge dial zone indicator 16 will now be described, referring to FIGS. 1-4. The user first thoroughly cleans the gauge face cover, and then measures the gauge zone desired to be covered by the gauge dial zone indicator 16. Once the gauge zone is measured, the user then measures the gauge dial zone indicator form 10 to cover the gauge zone of the gauge 20. The user then trims 12 the form 10 to these measurements, as shown in FIG. 1, thereby creating a trimmed gauge zone indicator 16. Once trimmed 12, the user peels off the release liner 24 to expose the adhesive backing 22 of the gauge dial zone indicator 16, as shown in FIG. 2. If a static cling material is used to make the indicator 16, then the indicator is simply peeled off of its mounting or backing sheet. Referring to FIGS. 3 and 4, the user then places the gauge dial zone indicator 16 over the measured gauge zone, pressing firmly to affix the gauge dial zone indicator to the gauge face cover 26.

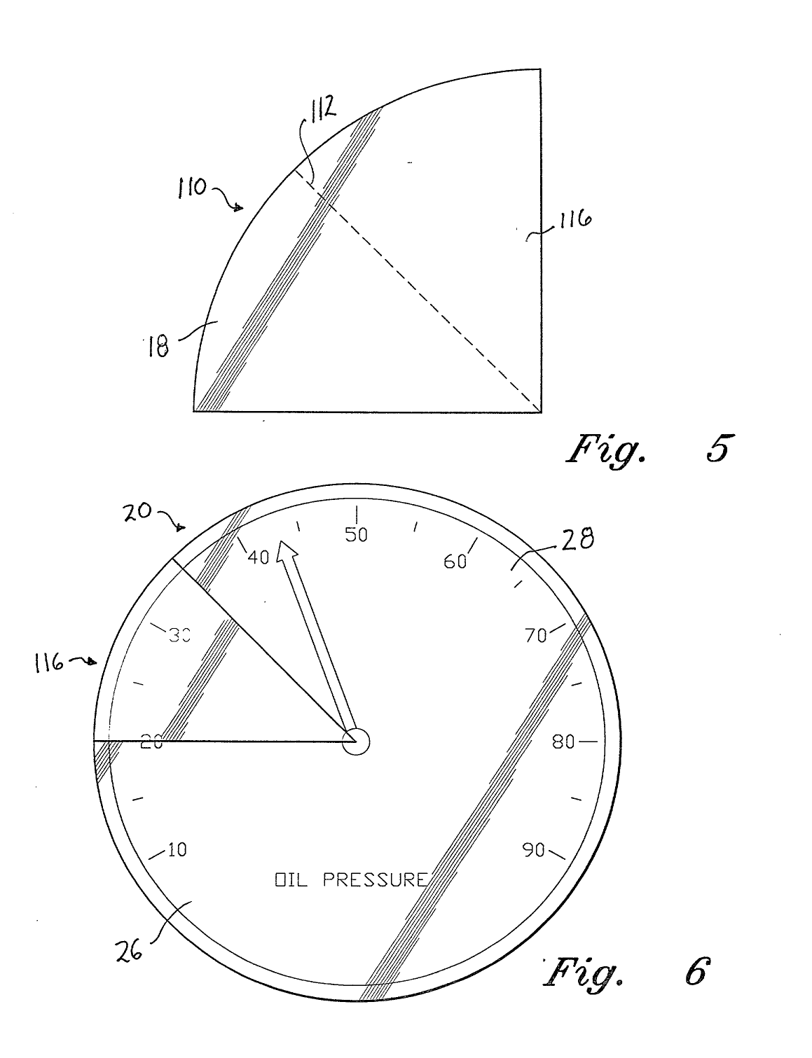

Referring to FIGS. 5 and 6, an alternative embodiment of a gauge dial zone indicator 116 is shown. In this case, a pie-shaped gauge dial zone indicator form 110 is provided for trimming, e.g., at 112, whereby a gauge dial zone indicator 116 may be affixed to a gauge face cover 26 of an analog gauge 20. The method of attachment of the second embodiment of the gauge dial zone indicator 116 is substantially the same as that for the first embodiment.

It is to be understood that the present invention is not limited to the embodiments described above, but encompasses any and all embodiments within the scope of the following claims.

I claim:

1. A gauge dial zone indicator comprising:
a colored planar form having adhesive backing; and
a release liner removably covering said adhesive backing.

2. The gauge dial zone indicator according to claim 1 wherein said colored planar form is transparent.

3. The gauge dial zone indicator according to claim 1 wherein said colored planar form is opaque.

4. The gauge dial zone indicator according to claim 1 wherein said colored planar form is comprised of a plastics material.

5. The gauge dial zone indicator according to claim 1 wherein said colored planar form is substantially pie-shaped.

6. The gauge dial zone indicator according to claim 1 wherein said colored planar form is in the shape of a quarter quoit.

7. A gauge dial zone indicator comprising:
a colored planar form of static cling material; and
a backing sheet mounting said planar form.

8. The gauge dial zone indicator according to claim 7 wherein said colored planar form is transparent.

9. The gauge dial zone indicator according to claim 7 wherein said colored planar form is opaque.

10. The gauge dial zone indicator according to claim 7 wherein said colored planar form is comprised of a plastics material.

11. The gauge dial zone indicator according to claim 7 wherein said colored planar form is substantially pie-shaped.

12. The gauge dial zone indicator according to claim 7 wherein said colored planar form is in the shape of a quarter quoit.

13. A method of installing a gauge dial zone indicator having one of a release liner covering an adhesive backing and a static cling backing and a mounting sheet, over a gauge having a transparent face cover, comprising the steps of:
a) measuring a distance of the gauge face to be covered by the gauge dial zone indicator;
b) trimming the indicator to match the distance of the gauge face;
c) peeling off the release liner to expose the adhesive backing or peeling of the indicator with its static cling backing from a mounting sheet; and
d) affixing the gauge dial zone indicator to the transparent face cover so that the gauge dial zone indicator covers the measured distance of the gauge face.
